(19) United States
(12) Patent Application Publication
(10) Pub. No.: US 2011/0035256 A1
(43) Pub. Date: Feb. 10, 2011

(54) Systems and methods for prioritized selection of media properties for providing user profile information used in advertising

(76) Inventors: ROY SHKEDI, NEW YORK, NY (US); ADI PINHASI, TEL AVIV (IL); DROR BEN-YISHAI, TEL AVIV (IL); MICHAEL BENEDEK, NEW YORK, NY (US)

Correspondence Address: LOUIS J. HOFFMAN, P.C., 11811 North Tatum Boulevard, Suite 2100, Phoenix, AZ, 85028, US

(21) Appl. No.: 12/536,451

(22) Filed: Aug. 5, 2009

(51) Int. Cl. G06Q 10/00; G06F 17/30; G06F 7/10; G06Q 30/00

(52) U.S. Cl. 705/10; 705/14.46; 707/E17.107; 707/E17.005

(57) ABSTRACT

Providing collected profiles by selecting one or more media properties and providing to each selected media property at least one profile attribute in a manner sufficient to enable the selected media property to electronically associate the provided profile attribute with the electronic visitor. Selected media properties can be a subset of one or more identified media properties. The media properties are selected or identified automatically, responsive to receiving current profile information about the visitor, among a multitude of media properties, based on a comparison of current and/or previous profile information received with previously received individualized requests for specific profiles, kinds of profiles, or profiles having specific attributes of interest to each of the media properties. A media property can be selected among those identified based on a media property selection history.

The subject matter of this application is related to the subject matter of (i) provisional application Ser. No. 60/805,114 filed Jun. 19, 2006 in the name of Roy Shkedi and entitled “Making collected profiles available to media properties identified as interested in profiles such as the ones collected,” and (ii) non-provisional application Ser. No. 11/765,433 filed Jun. 19, 2007 in the name of Roy Shkedi and entitled “Providing collected profiles to media properties having specified interests” (published Dec. 20, 2007 as US 2007/0294401 A1; referred to herein as the '433 application). Both of said applications are incorporated herein by reference.

### BACKGROUND

The field of the present invention generally relates to profile-based targeting advertisement placement services, wherein the targeting is based on behavioral, demographic, or other types of profile attributes. More specifically, the present invention relates to improving monetization of electronic advertisement placement within electronic or network traffic constraints imposed by electronic or network infrastructure, or established by profile suppliers, profile owners, or media properties.

Systems and methods disclosed in the '433 application can be summarized as follows. A full description of those systems and methods can be found in the '433 application itself.

A user accessing content or engaging in other activities via a telecommunications medium (e.g., via online access, wireless access, or television access) is “tagged” to allow subsequent recognition of that user during subsequent encounters (via the same medium or via a different medium). Typically, it is the user's media access device or online access device (e.g., computer, wireless handset or “smart phone,” PDA, television, or set-top box) that is tagged. For example, a computer used to access (i.e., electronically visit) an online site can be tagged by that online site with a cookie. The cookie enables that computer (and a particular user among multiple users of the computer if the users have separate login accounts) to be recognized upon subsequent access of that online site. Instead, or in addition, the online site can redirect the user's computer to access one or more other online sites or ad servers to receive cookies from them, to enable the user's computer to be recognized upon subsequent encounters with those other online sites or ad servers. Each cookie (or other suitable tag) can include or can be linked to varying amounts of information regarding the user's online activity, thereby establishing an electronic association between that information and the tag. “Tagging,” “placing a tag,” “cookie-ing,” “placing a cookie,” or similar terminology can denote placement of a new tag or cookie on a device, or recognition or modification of an existing tag or cookie on that device. Over time, an extensive profile of the user can be accumulated, with profile information being stored in the various cookies on the user's computer or being stored on one or more servers (e.g., one or more of the online sites' servers or ad servers that placed at least one cookie). Any entity that generates profile information for an electronic visitor can be referred to as a profile supplier.

Visitor profile information can include various attributes such as behavioral information, demographic information, or user-supplied information, some of which can be inferred and some of which must be observed or user-reported. Behavioral attributes can include, for example, information concerning content accessed (e.g., articles read, audio played, or video segments or programs watched), searches performed, or purchases made, via online access, wireless access, television access, or access via another telecommunications medium. Demographic attributes can include age, education level, income level, place of residence (neighborhood, city, state), and other information about the user. User-supplied attributes can often include personally identifiable information (PII; e.g., name, street address, phone number, or email address) or non-personally identifiable information (non-PII; e.g., birth date, employer, job title or job description).

An entity that (a) collects or generates profile information (e.g., a large search site) or that aggregates profile information from multiple profile suppliers, and (b) distributes profile information to other media properties, can be referred to as a profile owner. Note that a given entity can, but need not, act as both a profile supplier and a profile owner. A profile owner often collects profile information through redirecting of an electronic visitor from a profile supplier site to a profile owner server.

As profile information about a computer user is collected, it can be distributed by a profile owner to media properties for use in targeting advertisements to that user. A common method of distribution is by redirecting a user to that media property, along with at least a portion of the corresponding profile information or a link to that information. It is typically impractical and unnecessary to distribute all profiles to all media properties. Some media properties may be interested only in profiles that meet certain criteria or in certain attributes of a profile. Some profile suppliers may be interested in supplying profiles to only media providers that meet certain criteria.

Accordingly, the '433 application discloses, inter alia, systems and methods by which the profile owner selectively provides profiles to media properties. Typically, a media property provides to the profile owner a set of desired characteristics for the profile information to be supplied. For example, an ad network might desire to obtain profile information for only those users who have previously visited financial news sites or who have household income above a given level. An auto manufacturer advertiser might desire to obtain profile information for only those computer users who searched for specific makes or and models of cars. An online fashion site or a fashion TV channel might desire to obtain gender and age profile information to be able to better target ads to their media properties' visitors. An online retailer might desire to provide profile information to only online advertisers but not to competing online retailers. An online bookseller might desire to provide profile information only to publishing sites.

Any of those entities can provide to the profile owner a set of criteria for the types of profile information to be provided. A profile supplier can provide to the profile owner a list of, or a set of criteria for selecting, media properties to which its profile information is to be transmitted, or a list of, or criteria for selecting, what portions (i.e., what attributes) of the profile information will be transmitted. Likewise, a media property can provide to the profile owner a list of, or a set of criteria for selecting, profiles from which profile information is desired, or a list of, or criteria for selecting, what information or attributes are desired from those profiles. Examples of such methods are disclosed in co-owned U.S. Pat. No. 7,428,493 issued to Roy Shkedi and entitled “Descriptive-profile mercantile method,” which patent is incorporated herein by reference.

Selectively providing user profile information according to the systems and methods of the '433 application can result in enhanced monetization by a profile supplier or owner of its available profile information, and enhanced monetization by a media property of electronic advertising space (whether the media property owns the ad space, represents an owner of the ad space, has bought the ad space, or controls the ad space on a temporary or permanent basis).

In another common method of distribution of collected profile information, a profile owner can distribute profile information by so-called cookie syncing. For example, upon an initial encounter with a user, a profile owner can place a cookie on the user's access device that includes a unique cookie identifier. The profile owner then redirects the user to one or more media properties and provides the cookie identifier (or a pseudonym associated with the cookie identifier by the profile owner but typically not included in the cookie). Those media properties in turn place their own cookies on the user's device (or recognize their own cookies if previously placed). The media property cookie can include the profile owner's cookie identifier or pseudonym, or an identifier of the media property cookie and the identifier or pseudonym of the profile owner cookie can be associated in a database (typically maintained by the media property), in either case establishing a way to achieve an electronic association between the media property cookie (or other suitable tag) and profile information previously, currently, or subsequently linked to the profile owner cookie or other suitable tag (i.e., previous, current, or subsequent profile information, respectively). Upon subsequent encounters with the user, the profile owner collects additional profile information about the user and associates that information with the cookie identifier or pseudonym but need not redirect the user to the media properties that have already associated their cookies (via a previous redirect) with the profile owner's cookie. Instead, the profile owner can periodically (e.g., every several hours or daily) transmit to the media properties by any suitable medium a list or database of cookie identifiers or pseudonyms and associated profile information (all collected profile information, only profile information collected since the previous such transmission, or only profile attributes specifically requested by each media property). Alternatively, the media properties can be given access to the list or database maintained by the profile owner. Each media property can then recognize cookie identifiers or pseudonyms associated with its own cookies, retrieve the associated profile information supplied by the profile owner, and associate that profile information with its own cookies in its database. If the media property later recognizes a user with a corresponding media property cookie identifier, the associated profile information can be retrieved from the database and used to select targeted advertising, content, or other material likely to be of interest to the user based on his or her profile.

Terms used herein such as “transmitting,” “providing,” “distributing,” or “sending” profile information or a profile attribute shall be construed as any method, mechanism, or procedure, direct or indirect through an intermediary (such as the user's computer or other online access device), for enabling a media property to access that profile information or attribute, regardless of whether the information or attribute is electronically transferred to the media property, or merely associated with or made available to the media property in a way that enables subsequent access and use of the information or attribute (e.g., by inclusion in a cookie or in a database).

Even with the selective distribution of profile information disclosed in the '433 application or the cookie-syncing methodology described above, there are typically still practical limitations on the amount of profile information that can be distributed and the number of media properties to which it can be distributed. Ideally, upon encountering a particular electronic visitor (for the first time or on a subsequent encounter, in either case typically resulting from an electronic visit by a user to a profile supplier and a resulting electronic redirect of the user to the profile owner), a profile owner would electronically redirect that visitor to many, many media properties interested in that visitor's profile. In practice, more than a handful of redirects can begin to detract from the visitor's experience accessing the redirecting profile supplier site, often by slowing access to content of the redirecting profile supplier site to an unacceptable degree. As a result, many profile owners voluntarily limit the number of redirects for a given encounter with a user. Online sites, other profile suppliers, or media properties may choose to place limits on the number of redirects (from their own pages or by additional redirects) they will allow. Such limitations or similar constraints on electronic or network traffic can adversely affect the potential monetization of ad space or user profile information. In addition, conventional distribution of profile information by a profile owner to media properties, through redirecting a user, has been limited to distributing only profile attributes collected by the profile owner as a result of the user's current electronic visit to a profile supplier.

It is therefore desirable to develop systems and methods for maximizing monetization of media property ad space and user profile information within constraints imposed on the number of redirects. Those constraints can be voluntary or mandatory, and they can be imposed by limitations of electronic or network infrastructure, or by choice of profile suppliers, profile owners, or media properties.

### SUMMARY

A method for providing collected profiles using one or more computers comprises automatically identifying a set of one or more media properties, automatically selecting a subset of the identified media properties, and automatically providing at least one profile attribute to one or more of the selected media properties. The set made up of a plurality of media properties out of a multitude of media properties is identified based on a comparison of current or previous profile information received about the user with previously received individualized requests for specific profiles, kinds of profiles, or profiles having specific attributes of interest to each media property of the multitude. The set is identified in response to receiving via the Internet current profile information about a user that electronically visited a profile supplier. Each media property of the subset is selected based on a corresponding media property selection history. The provided profile attribute from the current or previous profile information is provided in a manner that enables the selected media property to electronically associate the provided profile attribute with the user. A system comprising one or more computers is structured and connected to perform the method. A computer-readable medium is encoded with a computer program, wherein execution of the computer program by one or more computers causes the one or more computers to perform the method. A computer program is downloaded over the Internet to one or more client computers, wherein execution of the computer program by at least one of the computers causes the executing computers to perform at least a portion of the method.

Another method for providing collected profiles using one or more computers comprises automatically selecting a set of one or more media properties and automatically providing at least one profile attribute to one or more of the selected media properties. The set made up of a plurality of media properties out of a multitude of media properties is selected based on a comparison of user profile information with previously received individualized requests for specific profiles, kinds of profiles, or profiles having specific attributes of interest to each media property of the multitude. The set is selected in response to receiving via the Internet profile information about a user collected as a result of a current electronic visit by the user to a first profile supplier. The compared user profile information includes the profile information collected during the current electronic visit and profile information collected during at least one previous electronic visit by the user to the first profile supplier or a second profile supplier. The provided profile attribute from the user profile information is provided in a manner that enables the selected media property to electronically associate the provided profile attribute with the user. A system comprising one or more computers is structured and connected to perform the method. A computer-readable medium is encoded with a computer program, wherein execution of the computer program by one or more computers causes the one or more computers to perform the method. A computer program is downloaded over the Internet to one or more client computers, wherein execution of the computer program by at least one of the computers causes the executing computers to perform at least a portion of the method.

Another method for providing collected profiles using one or more computers is performed by a profile owner and comprises automatically selecting one or more media properties for cookie-syncing, automatically providing information to the media properties to establish cookie-syncing, and automatically providing at least one profile attribute to one or more of the selected media properties. One or more media properties are selected that have not previously been provided with cookie-syncing information for the user or for which a time interval since previously providing such cookie-syncing information exceeds a predetermined time limit. The media properties are selected in response to receiving via the Internet current profile information about a user that electronically visited a profile supplier. Information, related to a profile owner cookie on an online access device used by the user to electronically visit the profile supplier, is provided to one or more of the selected media properties and is sufficient to enable the selected media property to establish cookie-syncing by the selected media property with respect to the user. At least one profile attribute from subsequent, current, or previous profile information about the user is provided together with information related to the profile owner cookie, whereby, as a result of the cookie-syncing, the selected media properties can each electronically associate the corresponding provided profile attribute with the user. A system comprising one or more computers is structured and connected to perform the method. A computer-readable medium is encoded with a computer program, wherein execution of the computer program by one or more computers causes the one or more computers to perform the method. A computer program is downloaded over the Internet to one or more client computers, wherein execution of the computer program by at least one of the computers causes the executing computers to perform at least a portion of the method.

Another method for providing collected profiles using one or more computers, comprises, responsive to receiving via the Internet current profile information about a user that electronically visited a profile supplier, automatically, with at least one of the computers, electronically redirecting the user via the Internet to a server of a media property, which electronic redirect includes one or more profile attributes from previous profile information about the user. A system comprising one or more computers is structured and connected to perform the method. A computer-readable medium is encoded with a computer program, wherein execution of the computer program by one or more computers causes the one or more computers to perform the method. A computer program is downloaded over the Internet to one or more client computers, wherein execution of the computer program by at least one of the computers causes the executing computers to perform at least a portion of the method.

A method for receiving collected profiles using one or more computers comprises receiving from a profile owner via the Internet, with at least one of the computers, an electronic redirect of a user that electronically visited a profile supplier, which electronic redirect is responsive to the profile owner receiving current profile information about the user and includes one or more profile attributes from previous profile information about the user. A system comprising one or more computers is structured and connected to perform the method. A computer-readable medium is encoded with a computer program, wherein execution of the computer program by one or more computers causes the one or more computers to perform the method.

Objects and advantages pertaining to profile-based targeting advertisement placement services that can improve monetization of electronic advertisement placement, within constraints on electronic or network traffic, may become apparent upon referring to the exemplary embodiments illustrated in the drawings and disclosed in the following written description or appended claims.

### DETAILED DESCRIPTION OF EMBODIMENTS

In many respects the methods disclosed herein are similar to those disclosed in the '433 application incorporated herein, and the steps and limitations shared by the methods of the '433 application and the currently disclosed methods need not be repeated in full detail herein.

When an electronic visitor accesses a profile supplier (e.g., an online site), the profile supplier can transmit profile information concerning that visitor (i.e., profile attributes arising from the current or previous encounters between the electronic visitor and the profile supplier) to a profile owner or store the profile information (acting as a profile owner). Transmission to a profile owner is often accomplished by electronically redirecting the visitor (along with the profile information) to a server controlled by the profile owner, which places a cookie or other tag on the visitor's computer or other access device. The profile information thus transmitted to the profile owner is referred to as “current” profile information, while profile information previously transmitted to the profile owner (e.g., from previous redirects from the same profile supplier or from one or more other profile suppliers) is referred to as “previous” profile information.

Upon receipt of the profile information, the profile owner proceeds to identify a set made up of a plurality of media properties out of a multitude of media properties that have requested user profile information. The identification is based on a comparison of the visitor's profile information and profile information indicated as being of interest to the media properties (e.g., types of profiles, specific profiles, types of profiles attributes, or specific profile attributes). The visitor's profile information compared can include the current profile information as well as previous profile information (if any) arising from previous encounters between the electronic visitor and one or more profile suppliers. Conventional identification or selection of media properties typically is based only on the current profile information. One or more individualized requests are received from each corresponding media property (typically in advance) that indicate that media property's interest in types of profiles, specific profiles, types of profiles attributes, or specific profile attributes. Those interests typically differ among the multitude of media properties, and those differences are reflected in the individualized requests. Requests for profiles or attributes can be received from a media property as a single transmission or as multiple, partial transmissions, and typically those requests can be subsequently added to or altered by the media property. The transmission of requests from media properties can be achieved in any suitable way, including transmission via computer network, email, facsimile, phone, or hard copy. In addition, the identification of media properties can be further limited by restrictions imposed by a profile supplier, a media property, or the profile owner. For example, a profile supplier might wish specifically to prevent any profile information it supplies from being provided to a media property that is a competitor. In another example, a profile owner might wish to avoid providing profile information to media properties that historically have exhibited poor revenue or profit generation from provided profiles. In another example, a media property might request that the profile owner not provide profile information from specific profile suppliers or types of profile suppliers whose supplied profile information has yielded unsatisfactory results in the past.

In one example, if the profile information indicates that the visitor has searched for airline tickets to southern California at a travel website offering airline tickets, media properties identified can include those that have specifically requested profile information pertaining to users interested in travel to southern California, e.g., ad networks selling travel-related ads, online sites that desire to tailor their online content to their electronic visitors and that have online content related to southern California, online advertisers that desire to deliver targeted ads to a target audience (e.g., airlines flying to southern California or southern California hotels), ad exchanges that desire to offer travel data to advertisers buying targeted ads via the exchange (regardless of the medium of the ads), or media-buying firms that desire to profit from arbitraging ad space (e.g., by buying low-value ad space and selling it to various advertisers for a higher price as targeted ad space).

In another example, if the visitor's profile information indicates the user has searched for an online florist, media properties identified can include, e.g., social network sites desiring to sell targeted ads to a specific online florist, e.g., 1800flowers.com. In another example, if the visitor's profile information indicates user interest in a particular type of product, an identified media property can be a general interest online site (e.g., an online news site) that has an agreement with a specific advertiser (e.g., a vendor of the product) to display ads for that advertiser to site visitors known to have interest in the advertiser's product.

Ideally, the profile owner could provide the visitor's profile information to an unlimited number of media properties among the set thus identified, thereby maximizing the potential advertising revenue or profit realized by the profile supplier, profile owner, or media property. Profile information (i.e., one or more profile attributes) can be provided to a media property in any suitable way (e.g., by including the provided attributes in an electronic redirect to the media property or by including the provided attributes in a database provided to or accessible by the media property). In addition to transmitting the profile information to the media property, the electronic visitor typically is electronically tagged in some way to enable the media property to recognize the visitor when encountered later. Tagging is typically accomplished by the profile owner electronically redirecting the visitor to a server controlled by the media property, which places a new cookie or other suitable tag on the visitor's computer or uses an existing cookie or tag on the user's computer. The new profile information can be stored in the media property cookie itself or in a database (maintained by the profile owner, media property, or other entity) where a corresponding cookie identifier (or pseudonym) is used as a record locator. In either case, an electronic association is established between the media property tag and the profile information. Alternatively or in addition, the media property can arrange tagging of one or more other access devices of the visitor. Any such tagging by a media property (i.e., placement, recognition, or modification of a tag) can be performed by the media property itself, or on behalf of or in concert with the media property by another entity, e.g., a media property can tag a television set-top box by directing or requesting a television service provider to tag the set-top box. Similarly, any reading or recognition of a tag by a media property can be performed by the media property itself, or on behalf of or in concert with the media property by another entity.

Conventionally, in methods wherein profile attributes are provided to a media property by including those attributes in an electronic redirect, only current profile attributes are provided, i.e., the redirect from the profile owner only includes one or more profile attributes collected by the profile owner as a result of the user's current electronic visit to a profile supplier. However, it would also be desirable to provide, by electronically redirecting from a profile owner to a media property following a current electronic visit to a profile supplier, profile attributes that were collected by the profile owner during one or more previous electronic visits to one or more profile suppliers (including the same profile supplier or different profile suppliers). In an implementation according to the present disclosure, an electronic redirect from a profile owner to a media property can include one or more profile attributes collected by the profile owner as a result of one or more previous electronic visits by the user to one or more profile suppliers (including the same profile supplier or different profile suppliers). The provided attributes from such previous profile information can be included in the redirect instead of or in addition to one or more profile attributes from current profile information. Inclusion of attributes from the previous profile information enables the previous profile information to be provided to a larger number of media properties than might be possible using conventional methods, wherein those attributes are only provided by an electronic redirect from the profile owner following the electronic visit that caused their collection by the profile owner. Inclusion of previous profile information in a redirect from a current profile supplier visit can be implemented independently or in conjunction with other methods disclosed herein.

There are practical limitations to the number of media properties that can have readable tags (e.g., cookies) placed or modified on a given visitor's computer in response to a given transmission of profile information from the profile supplier. For example, using currently available hardware and software, redirecting a visitor's computer to more than a handful of media property servers typically degrades the visitor's access to the profile supplier site to an unacceptable degree. Too many redirects, from the profile supplier site or (more typically) from the profile owner's server, often slows access to desired content or overburdens network hardware or software. In many instances, profile owners voluntarily limit the number of redirects from their servers to other media properties to avoid degrading a site visitor's access to the profile supplier's site. Profile suppliers (e.g., online sites) can impose limits on the number of redirects that are permitted (either redirects from the online site or redirects from a redirect server). At present a common voluntary limitation is five total redirects per access of an online site, but that number can vary among online sites and profile owners and may change with evolving hardware and software capability.

Given the limitations on the number of redirects, the profile owner can only provide profile information to, and arrange electronic association between that profile information and media property tags for, a limited subset of the identified media properties per encounter with the electronic visitor. Systems and methods are disclosed herein (i) for providing profile information, over multiple encounters with a given user, to a larger number of identified media properties than can be provided with such information during a single encounter, or (ii) for selecting, among the identified media properties, those that can result in realization of greater advertising revenues or profits for the profile supplier, profile owner, or media property.

In one implementation, the profile owner maintains a record for each of many users, for each of which the profile owner has collected profile information, of which media property has received access to which profile attributes collected about each user. Such a record (or portion thereof) is an example of a media property selection history for a user. In another implementation, the profile owner maintains a record for each media property of whether the media property has received any profile information about each of many users for which the profile owner has collected profile information, or which profile information about which of those users has been received by each media property. Such a record (or portion thereof) is an example of a media property selection history for a media property. In either example (or in other implementations), each record can be included in one or more tags on the user's computer or other access device or can be recorded in a database (wherein a tag identifier can be used as a record locator). Records for a given user or for a given media property can be distributed among multiple locations, including the user's computer or one or more central databases maintained by the profile owner or one or more media properties. Regardless of the specific implementation, it can be typically desirable also to record in a media property selection history the time and date when profile information for a user was collected or provided to a media property. If a given media property has not yet received any profile information for a given user (or for any user), that fact can comprise the corresponding media property selection history; such a lack of history can be indicated in the record by a null entry for that combination of media property and user, or by a lack of any entry for that combination. Because a profile owner server typically is associated with (e.g., via redirects) numerous profile supplier servers, there is a reasonably high probability that a given profile owner server will encounter any given one of many users on multiple occasions as each user electronically visits a profile supplier and is redirected to the profile owner. Each such encounter typically supplies at least one additional piece of profile information (i.e., at least one additional profile attribute) and provides an additional opportunity to transmit profile information to one or more media properties and enable those media properties to tag the visitor.

Upon a first encounter with a given visitor, the profile owner tags the visitor itself (e.g., “cookies” the visitor) and arranges for tags readable by several selected media property servers to be electronically associated with the visitor (e.g., by redirecting the visitor to the media properties' servers to be associated with their cookies). Assuming a limit of five total redirects, the visitor can be redirected to a subset comprising four identified media property servers. The limit of five redirects is arbitrary and is assumed in the following discussion; any other suitable numerical limit can be employed, which can be constant or can vary depending on parameters such as measured network speed or the speed of a user's particular computer system. Corresponding profile information pertinent to each of the four selected media properties can be contained by or linked to each of the cookies (i.e., electronically associated). The first subset of four media properties can be selected based on any desired criterion (contractual obligations, guaranteed or potential revenue or profit generated, alphabetically, visitor traffic volume, and so on) or combination of criteria, or even randomly, from among those media properties identified as being interested in the given visitor profile or attributes thereof. The profile owner records the identities of the first four media properties to which the electronic visitor was redirected and the corresponding profile information or attributes provided to them.

Upon a second or subsequent encounter with the electronic visitor, the profile owner can add to the profile information, redirect the visitor to a subset of four selected media properties, and provide to each of those media properties corresponding profile information or attributes of interest. The four selected media properties can differ from any of those previously selected, or can include one or more media properties selected upon previous encounters. Profile attributes provided to each media property (i) can be limited to those added during the most recent encounter between the profile owner and the visitor, or (ii) can be selected from among profile attributes acquired over one or more previous encounters between the profile owner and the visitor (and in some instances might not include any profile attributes added during the most recent encounter). The four selected media properties can cookie the visitor (or add to or modify a previously placed cookie, or associate additional profile attributes to a database entry for a corresponding recognized cookie identifier), and the profile owner records the media property identities and the corresponding profile information provided to them. This procedure can be repeated on each subsequent encounter of the electronic visitor by the profile owner, and eventually a large number (dozens or even hundreds) of media properties can read tags linked to the electronic visitor and access varying amounts of profile information pertaining to that visitor. A delay can occur between collection of a profile attribute by a profile owner and supplying that profile attribute to an interested media property, when profile attributes from previous visitor encounters are provided to the media property.

The selection of a subset of media properties upon each subsequent electronic encounter between a given user and the profile owner can be based on the media property selection histories in any suitable or desirable way. For example, if a given media property has not previously been provided profile information for a given user, then the media property can be selected on that basis. Conversely, a media property whose selection history indicates it has been selected previously for a given user might specifically not be chosen. In some examples a media property selection history includes a list of which profile attributes have already been provided to the media property for a given user. If so, then that media property can be selected based on one or more profile attributes it has previously requested that have been collected for the given user but have not been previously provided to the media property. Conversely, a media property might specifically not be selected based on which profile information it has already received for the given user.

If there are only a limited number of media properties interested in the profile attributes of a particular electronic visitor, the above procedure can be employed to cycle through the list of interested media properties more than once. In other words, if after a given number of encounters with the profile owner all interested media properties have had an opportunity to tag the visitor, on the next encounter the visitor can be redirected to some of those media properties for a second time (presumably along with additional profile information). The second “pass” can be done in the same order as the first, or in a different order determined according to the same or different criteria. The process can continue as long as the visitor continues to be recognized upon subsequent encounters with the profile owner server, with the profile owner upon each encounter referring to its stored listing of which media properties have been given which profile information, how long ago, and then choosing the next media properties accordingly. Upon each subsequent redirect to a media property, the profile owner can provide all profile attributes of interest to that media property (even if already provided with a previous redirect). Alternatively, the profile owner (i) can track which profile attributes have already been provided to which media properties, and (ii) after receiving additional profile information and upon a subsequent redirect to a given media property, can provide only those additional profile attributes of interest not already provided to that media property (i.e., a differential profile).

The process described above can continue indefinitely, as long as the electronic visitor continues to be recognized upon subsequent encounters with the profile owner server. If the tags are deleted by the visitor, the process must necessarily stop, because there is no longer any way to recognize the electronic visitor as being associated with the profile information, which would typically be disregarded or discarded. The process can be terminated and the recorded profile information discarded or disregarded after a predetermined time interval following the most recent visitor encounter with the profile owner server. The predetermined time interval can be any desired length. For example, a time interval can be chosen so that if the visitor has not been encountered, it is likely that the visitor has deleted the tags associated with the profile owner or media properties. Suitable time intervals might be one week, one month, several months, or other longer or shorter intervals. The time interval can vary among different electronic visitors based on observed prior encounters with the profile owner server. For example, if a given visitor is encountered by the profile owner server at least once a day for several days in a row and then is not encountered for several days in a row, it might reasonably be inferred that the visitor has deleted the tags, and the corresponding profile information can be disregarded or discarded. If another visitor is encountered on average only once a week, then waiting several weeks before disregarding or discarding the corresponding profile information might be appropriate.

The distribution of specific profile attributes can be terminated based on the nature of the profile information or the interested media properties. Certain profile information might be relevant for only a limited period of time. For example, it has often been observed that many examples of behavioral profile information (such as a search for a specific product or service) are valuable for targeted-advertising purposes only for about two weeks after the observed behavior. For example, if a visitor has not searched for a given product within the last two weeks, then he or she becomes of no interest to a media property desiring to target ads to shoppers interested in that product. Accordingly, there would be no benefit to the profile owner or the media properties from providing that behavioral profile attribute more than two weeks after its collection, and the attribute could be deleted from the profile after that time has passed. In another example, if media properties were initially identified based on the visitor's interest in an event on a specific date, once that date passes, that profile information may not be relevant and can be disregarded or discarded.

The implementation described above enables many or even all of the identified media properties to tag the electronic visitor. Other implementations can be employed wherein additional criteria are employed to select among the identified media properties, and such implementations can result in some identified media properties being selected by the profile owner to tag the electronic visitor often or even always, while others are selected rarely or not at all. A software decision engine can be implemented to select among the identified media properties based on any suitable criteria, e.g., to increase or maximize advertising revenue or profits generated by the selection.

In various implementations involving a decision engine, a media property can be selected based on an estimate of revenue or profit expected to result from its selection. Examples of related methods are disclosed in co-owned non-provisional application Ser. No. 11/763,286 filed Jun. 14, 2007 in the name of Roy Shkedi and entitled “Media properties selection method and system based on expected profit from profile-based ad delivery” (published Jan. 10, 2008 as US 2008/0010155 A1; referred to herein as the '286 application), which application is incorporated herein by reference. In contrast to systems and methods disclosed herein, the '286 application discloses selection of a media property for presentation of an advertisement based on the profit (if any) expected to be realized from presentation of that advertisement on that media property. However, the '286 application does not disclose providing profile information to media properties, or any basis for selecting media properties to receive that profile information.

In one example, the profile owner might have arrangements with certain media properties wherein the media property pays the profile owner for each redirected visitor having desired profile attributes, regardless of subsequent use of that profile by the media property (i.e., upfront payment). The profile owner might have arrangements with other media properties wherein the media property pays the profile owner based on subsequent use of the profile information (i.e., usage-based payment).

For a given visitor and profile attribute, a comparison can be made between an upfront payment from one media property and an estimated usage-based payment from another media property. The usage-based payment can be estimated based on estimates or data for the reach and frequency of the media property (defined below) and an expected lifetime of the profile attribute (e.g., about two weeks for some behavioral attributes as described above; different attributes can have differing lifetimes). Such a comparison can be done ahead of time or can be done in real time when a profile attribute is collected.

In one implementation of the up-front payment example, some or all the media properties can set a bid price (which they could amend at any time) identifying how much they are willing to pay to receive a profile attribute regardless of subsequent use of that profile by the media property, and the profile owner's system will automatically take into account the prices bid for each attribute when calculating the expected advertising revenues or profits from each media property. The highest-bidding media properties would receive their desired profile attributes.

In either an enhancement of the previous implementation or in other possible implementations, the profile owner's server multiplies the price a media property is willing to pay for a profile, profile attribute, or profile type (whether as an up-front payment, as a usage-based payment, or as the potential revenues or profit from providing profile information to the media property) by a “quality factor” intended to represent other parameters of importance to the profile owner. Such other parameters could be derived from, for example, the total advertising budgets spent by a media property with the profile owner, the importance of the media property (for example, a media property using the profile owner's profiles for the first time but with potential to become a large customer could receive a priority), or ad viewers' satisfaction levels with the media property's ads (satisfied ad viewers would not opt-out from having their data collected and distributed by the media owner for example). Instead of checking the potential revenue or profit from the distribution of a profile, profile attribute, or profile attributes, the profile-owner's server checks a number composed of the potential revenue or profit from possible immediate distribution of a profile multiplied by the quality score. The quality score weighting, in some cases, might cause a first media property to be selected to receive its desired profile even if it provides less revenue or profit to the profile owner from the immediate profile distribution than a second media property.

In another implementation involving a decision engine, a media property can be selected based on an estimate of the odds of the media property encountering the electronic visitor as well as the expected frequency of the encounters. If, for example, a usage-based revenue arrangement between a profile owner and a media property determines revenue paid to the profile owner based on the number of times the media property uses the visitor profile information (i.e., the number of times the media property encounters a previously redirected visitor and uses profile information received from the profile owner to deliver a targeted ad), then the profile owner can simply select among the identified media properties those likely to have the highest product of reach (i.e., the fraction of all users encountered per unit time), frequency (i.e., the average number of encounters with a particular visitor per unit time), and price per use (which can vary among media properties or according to the number or type of attributes provided from the profile). For example, a first media property requesting only a few profile attributes may nevertheless be selected over a second media property requesting many profile attributes, based on a higher estimated frequency and reach of the first media property.

In another implementation involving a decision engine, a media property can be selected based on a complex estimation of revenue generated based on an estimated lifespan of the visitor's profile information or tags, an estimated duration of the relevance of the visitor profile information, estimated frequency with which the media property might expect to encounter a given visitor, estimated reach of the media property (i.e., what fraction of the population of all possible visitors typically visits the media property), and/or estimated revenue generated per visitor encounter with the media property server. Such an estimate or calculation might in some circumstance be too complex or time-consuming, but if sufficient time and computing resources are available, then such an estimate or calculation can be undertaken. Several examples might serve to illustrate this implementation.

The profile owner can estimate an expected lifetime for the overall visitor profile, including any cookies or other tags that might have been stored that are associated with the profile. That estimate can be an industry-wide average of all profile lifetimes or an average lifetime for visitors having similar profile attributes, or the estimate can be inferred from a particular visitor's previously observed behavior recorded by the profile owner. That profile lifetime can be compared to the average frequency with which a given media property typically encounters a given visitor (any visitor or one having similar profile attributes), and a probability can be calculated that the profiled visitor will encounter the media property server within the expected lifespan of the profile. That probability can be multiplied by the revenue generated per encounter (which varies among media properties and according to the type of profile information) to arrive at an expected revenue generated by selecting that media property. Similar calculations can be performed for the multiple identified media properties, and those media properties producing higher expected generated revenue can be selected for a redirect.

Instead of or in addition to using the expected lifetime of the overall profile, the relevant lifespan of pertinent portions of the profile can be used. That lifespan can be shorter than the overall profile lifetime. For example, a given electronic visitor might be observed to have not erased cookies for over a month. That same visitor's profile includes a search for “flowers” conducted one week ago. Because it has been observed that most visitors that purchase flowers do so within only three days of searching for “flowers,” then that profile attribute can be disregarded when selecting a media property for redirecting a visitor. In another example, multiple profile attributes can be present that have different effective lifetimes (e.g., interest in a concert next week versus the profiled visitor's gender). An identified media property can be selected first based on the profile attribute having the shorter lifespan (e.g., a media property is selected today based on interest in the concert, on the assumption that there will be later opportunities to select a media property based on gender). Another parameter that could be considered is the number of encounters between a given electronic visitor and the profile owner's server expected to occur within the time interval after the current encounter and before the profile owner tag is expected to be erased. Based on the expected number of encounters and the expected time interval, in some implementations, iterative calculations can be employed to compare estimated revenues or profits generated from various scenarios wherein different media properties are selected to receive profile attributes upon different expected future encounters.

To speed up complex calculations of expected revenue or profit based on profile/attribute lifespan or media property reach/frequency, the bulk of the calculations can be done in advance of a given encounter between the electronic visitor and the profile owner, and an ordered list of media properties can be generated for redirecting the visitor upon the next encounter. Upon each subsequent encounter between the visitor and the profile owner, the top-listed media properties can be selected for redirecting or otherwise arranging for association of profile attributes with the selected media properties tags, and a new calculation using the new profile information can be done to prepare for the next encounter with the visitor. Alternatively, an incremental (and presumably faster) calculation can be done to refine the revenue estimates based on the new profile information added by the most recent redirecting profile supplier, and the top-listed media properties on the refined list can be selected for redirecting or otherwise tagging the visitor. In another implementation, an advance calculation of estimated revenue or profit can also include one or more predicted profile attributes likely to be collected upon the next encounter with the electronic visitor. Several different revenue or profit estimates can be generated, each assuming different additional profile attribute or attributes. When the next encounter with the visitor occurs, if the collected profile attribute or attributes are among the predicted candidates, then media properties can be selected based on the corresponding calculation of projected revenue or profit.

In performing a calculation of estimated revenue or profit that might be generated by redirecting an electronic visitor to a particular media property, revenue amounts paid to the profile suppliers (by the profile owner or by the media properties) can be included in the calculation.

In several of the implementations described above, a small media property typically would receive fewer redirects than a large media property due to the lower revenues or profits it would be expected to generate for the profile owner due to its smaller reach and frequency. The decision engine might be likely to select the smaller media property when a large number of attributes of interest to the small media property have been accumulated for a given computer user, thereby causing the expected revenues or profits from the smaller media property to match or exceed the revenues or profits expected from a large media property based on only one or two new attributes collected since the visitor was last redirected to it.

In implementations wherein cookies of the profile owner and the media properties are synced (typically by reference to a profile owner cookie identifier, as described above), the above described methods would enable cookie syncing with a larger number of media properties. By recording to which media properties an electronic visitor has already been redirected (to provide information to the media property sufficient to establish cookie-syncing), upon each subsequent encounter with the electronic visitor, the profile owner can redirect to, and therefore cookie-sync with, additional media properties. It is typically desirable also to record the time and date of each redirect (to take into account cookie deletion, for example when a profile owner cookie is present while some media properties cookies might have been deleted). In this way, substantially more media properties can be synced to a single profile owner cookie than would be without tracking and recording of already-synced media properties. In one example of a cookie-sync implementation, media properties can be selected for redirect and cookie-syncing based on their requests for specific profiles, attributes, or kinds thereof, as well as whether and when they were previously selected. Alternatively, media properties can be selected for redirect and cookie-syncing by the profile owner only on the basis of whether or when they were previously selected. Selection of specific profiles, attributes, or kinds thereof to be transmitted to a given media property is then based on comparison of the collected profile attributes and the media property's request.

In the various implementations disclosed herein, tags are placed or recognized to enable electronic association of profile attributes provided to media properties with a user, after that user has electronically visited a profile supplier. In many instances, the tags are placed or recognized on the same online access device that was used to visit the profile supplier site. In other instances, tags can also or instead be placed or recognized on other user devices, e.g., a different online access device or a television set-top box. Methods for associating the user's online access device with another online access device or with a television set-top box are disclosed in (i) non-provisional application Ser. No. 11/736,544 filed Apr. 17, 2007 in the name of Roy Shkedi and entitled “Targeted television advertisements based on online behavior” and (ii) non-provisional application Ser. No. 11/968,117 filed Dec. 31, 2007 in the names of Roy Shkedi and Ronen Shlomo and entitled “Targeted online advertisements based on viewing or interacting with television advertisements.” Both of said applications are incorporated herein by reference.

The methods disclosed herein are typically performed using software of any suitable type running on one or more computers, one or more of which are connected to the Internet. The software can be self-contained on a single computer, duplicated on multiple computers, or distributed with differing portions or modules on different computers. The software can be executed by one or more servers under control of the profile owner, or the software (or a portion thereof) can be executed by an online access device used by the electronic visitor (e.g., a desktop or portable computer; a wireless handset, “smart phone,” or other wireless device; a personal digital assistant (PDA) or other handheld device; a television or set-top box). Software running on the visitor's online access device can include, e.g., Java™ client software or so-called adware. A method for providing collected profiles can include downloading such software to an electronic visitor's online access device to perform there one or more of the methods disclosed herein.

The profile information described can be included as a portion of the tags or cookies placed on a visitor's device, or the tags or cookies can merely include an identifier associated with the visitor's profile that is stored elsewhere (e.g., on a profile owner server, profile supplier server, or media property server). The profile information need not be stored in a single location or under the control of a single entity, nor does control or use of the profile information need to be performed at a single location or under control of a single entity.

The systems and methods disclosed herein can be implemented as general or special purpose computers or servers or other programmable hardware devices programmed through software, or as hardware or equipment “programmed” through hard wiring, or a combination of the two. A “computer” (e.g., a “server” or an online access device) can comprise a single machine or processor or can comprise multiple interacting machines or processors (located at a single location or at multiple locations remote from one another). A computer-readable medium can be encoded with a computer program, so that execution of that program by one or more computers causes the one or more computers to perform one or more of the methods disclosed herein. Suitable media can include temporary or permanent storage or replaceable media, such as network-based or Internet-based or otherwise distributed storage of software modules that operate together, RAM, ROM, CD-ROM, CD-R, CD-R/W, DVD-ROM, DVD±R, DVD±R/W, hard drives, thumb drives, flash memory, optical media, magnetic media, semiconductor media, or any future storage alternatives.

It is intended that equivalents of the disclosed exemplary embodiments and methods shall fall within the scope of the present disclosure or appended claims. It is intended that the disclosed exemplary embodiments and methods, and equivalents thereof, may be modified while remaining within the scope of the present disclosure or appended claims.

For purposes of the present disclosure and appended claims, the conjunction “or” is to be construed inclusively (e.g., “a dog or a cat” would be interpreted as “a dog, or a cat, or both”; e.g., “a dog, a cat, or a mouse” would be interpreted as “a dog, or a cat, or a mouse, or any two, or all three”), unless: (i) it is explicitly stated otherwise, e.g., by use of “either . . . or”, “only one of . . . ”, or similar language; or (ii) two or more of the listed alternatives are mutually exclusive within the particular context, in which case “or” would encompass only those combinations involving non-mutually-exclusive alternatives. For purposes of the present disclosure or appended claims, the words “comprising,” “including,” “having,” and variants thereof shall be construed as open-ended terminology, with the same meaning as if the phrase “at least” were appended after each instance thereof.

What is claimed is:

1. A method for providing collected profiles using one or more computers, the method comprising:
(a) responsive to receiving via the Internet current profile information about a user that electronically visited a profile supplier, automatically identifying, with at least one of the computers, a set made up of a plurality of media properties out of a multitude of media properties based on a comparison of current or previous profile information received about the user with previously received individualized requests for specific profiles, kinds of profiles, or profiles having specific attributes of interest to each media property of the multitude;
(b) automatically selecting, with at least one of the computers, a subset of one or more media properties out of those identified in part (a), wherein each media property of the subset is selected based on a corresponding media property selection history; and
(c) automatically providing, with at least one of the computers, to one or more of the selected media properties one or more profile attributes from the current or previous profile information in a manner that enables the selected media property to electronically associate the provided profile attribute with the user.

2. The method of claim 1 wherein the one or more computers include at least one server connected to the Internet.

3. The method of claim 1 wherein the one or more computers include an online access device used by the user to electronically visit the profile supplier.

4. The method of claim 1 wherein media properties are selected in part (b) up to a predetermined limit on the number of media properties to be selected responsive to each reception of current profile information.

5. The method of claim 1 wherein the media property selection history in part (b) is based on whether the corresponding selected media property was selected previously for the user or on a time interval since previous selection, if any, of that media property for the user.

6. The method of claim 1 wherein the media property selection history in part (b) is based on which one or more profile attributes were provided previously to the corresponding selected media property for the user.

7. The method of claim 6 wherein media properties selected in part (b) include one or more identified media properties for which the current or previous profile information about the user includes one or more profile attributes requested in part (a) that have not been previously provided to the selected media property.

8. The method of claim 1 wherein the selecting in part (b) is further based on calculated advertising revenue or profit potentially realizable as a result of providing to the selected media property one or more profile attributes from the current or previous profile information.

9. The method of claim 1 wherein the selecting in part (b) is based on multiplication of calculated advertising revenue or profit, potentially realizable as a result of providing to the selected media property one or more profile attributes from the current or previous profile information, by a media property quality factor.

10. The method of claim 1 wherein the providing in part (c) comprises providing access by the selected media property to the one or more profile attributes and to information associated with a tag readable by the media property that is sufficient to enable the media property to electronically associate the one or more profile attributes with the user.

11. The method of claim 1 wherein the providing in part (c) comprises electronically redirecting the user to a server of the selected media property, thereby enabling the selected media property to place or recognize a tag readable by the selected media property.

12. The method of claim 11 wherein the redirecting of the user to the media property server provides information sufficient to enable the selected media property to electronically associate the one or more profile attributes with the tag readable by the selected media property.

13. The method of claim 12 wherein the information provided by redirecting includes the one or more profile attributes.

14. The method of claim 1 wherein the providing in part (c) comprises providing to the media property information and access to an online access device used by the user to electronically visit the profile supplier, which information and access are sufficient to enable the media property (i) to place or recognize a tag on the online access device and (ii) to electronically associate the tag or an identifier thereof with the one or more provided profile attributes, which tag is readable by the selected media property.

15. The method of claim 1 wherein the providing in part (c) comprises providing to the media property information sufficient to enable the media property (i) to place or recognize a tag on an access device other than an online access device used by the user to electronically visit the profile supplier and (ii) to electronically associate the tag or an identifier thereof with the one or more provided profile attributes, which tag is readable by the selected media property.

16. The method of claim 1 wherein the providing in part (c) comprises providing to the media property information sufficient to enable the media property (i) to place or recognize a tag on a television set-top box used by the user to receive television service and (ii) to electronically associate the tag or an identifier thereof with the one or more provided profile attributes, which tag is readable by the selected media property.

17. The method of claim 1 wherein the providing in part (c) comprises creating or updating a database record linking the one or more profile attributes and the user.

18. The method of claim 1 further comprising selecting out of the current or previous profile information the one or more profile attributes provided in part (c).

19. The method of claim 18 wherein one or more profile attributes provided in part (c) are selected based on whether the profile attribute was provided previously to the selected media property for the user or on a time interval since the profile attribute was provided previously to the selected media property for the user.

20. The method of claim 18 wherein one or more profile attributes provided in part (c) are selected based on calculated advertising revenue or profit potentially realizable from the media property for providing the profile attribute to the selected media property for the user.

21. The method of claim 18 wherein one or more profile attributes provided in part (c) are selected out of profile attributes not previously provided to the selected media property for the user.

22. The method of claim 1 further comprising receiving with at least one of the computers the individualized requests for specific profiles, kinds of profiles, or profiles having specific attributes of interest to each media property of the multitude.

23. A system comprising one or more computers, which system is structured and connected to:
(a) responsive to receiving via the Internet current profile information about a user that electronically visited a profile supplier, identify automatically, with at least one of the computers, a set made up of a plurality of media properties out of a multitude of media properties based on a comparison of current or previous profile information received about the user with previously received individualized requests for specific profiles, kinds of profiles, or profiles having specific attributes of interest to each media property of the multitude; and
(b) select automatically, with at least one of the computers, a subset of one or more media properties out of those identified in part (a), wherein each media property of the subset is selected based on a corresponding media property selection history; and
(c) provide automatically, with at least one of the computers, to one or more of the selected media properties one or more profile attributes from the current or previous profile information in a manner that enables the selected media property to electronically associate the provided profile attribute with the user.

24. A computer-readable medium encoded with a computer program, wherein execution of the computer program by one or more computers causes the one or more computers to perform a method comprising:
(a) responsive to receiving via the Internet current profile information about a user that electronically visited a profile supplier, automatically identifying, with at least one of the computers, a set made up of a plurality of media properties out of a multitude of media properties based on a comparison of current or previous profile information received about the user with previously received individualized requests for specific profiles, kinds of profiles, or profiles having specific attributes of interest to each media property of the multitude;
(b) automatically selecting, with at least one of the computers, a subset of one or more media properties out of those identified in part (a), wherein each media property of the subset is selected based on a corresponding media property selection history; and
(c) automatically providing, with at least one of the computers, to one or more of the selected media properties one or more profile attributes from the current or previous profile information in a manner that enables the selected media property to electronically associate the provided profile attribute with the user.

25. A method comprising downloading over the Internet to one or more client computers a computer program, wherein execution of the computer program by at least one of the computers causes the executing computers to perform a method comprising:
(a) responsive to receiving via the Internet current profile information about a user that electronically visited a profile supplier, automatically identifying, with at least one of the computers, a set made up of a plurality of media properties out of a multitude of media properties based on a comparison of current or previous profile information received about the user with previously received individualized requests for specific profiles, kinds of profiles, or profiles having specific attributes of interest to each media property of the multitude;
(b) automatically selecting, with at least one of the computers, a subset of one or more media properties out of those identified in part (a), wherein each media property of the subset is selected based on a corresponding media property selection history; and
(c) automatically providing, with at least one of the computers, to one or more of the selected media properties one or more profile attributes from the current or previous profile information in a manner that enables the selected media property to electronically associate the provided profile attribute with the user.

26. A method for providing collected profiles using one or more computers, the method comprising:
(a) responsive to receiving via the Internet profile information about a user collected as a result of a current electronic visit by the user to a first profile supplier, automatically selecting, with at least one of the computers, a set made up of a plurality of media properties out of a multitude of media properties based on a comparison of user profile information with previously received individualized requests for specific profiles, kinds of profiles, or profiles having specific attributes of interest to each media property of the multitude, wherein the compared user profile information includes the profile information collected during the current electronic visit and profile information collected during at least one previous electronic visit by the user to the first profile supplier or a second profile supplier; and
(b) automatically providing, with at least one of the computers, to one or more of the selected media properties one or more profile attributes from the user profile information in a manner that enables the selected media property to electronically associate the provided profile attribute with the user.

27. The method of claim 26 wherein the one or more computers include at least one server connected to the Internet.

28. The method of claim 26 wherein the one or more computers include an online access device used by the user to electronically visit the first profile supplier.

29. The method of claim 26 wherein the providing in part (b) comprises providing access by the selected media property to the one or more profile attributes and to information associated with a tag readable by the media property that is sufficient to enable the media property to electronically associate the one or more profile attributes with the user.

30. The method of claim 26 wherein the providing of part (b) comprises electronically redirecting the user to a server of the selected media property, thereby enabling the selected media property to place or recognize a tag readable by the selected media property.

31. The method of claim 30 wherein the redirecting of the user to the media property server provides information sufficient to enable the selected media property to electronically associate the one or more profile attributes with the tag readable by the selected media property.

32. The method of claim 31 wherein the information provided by redirecting includes the one or more profile attributes.

33. The method of claim 26 wherein the providing in part (b) comprises providing to the media property information and access to an online access device used by the user to electronically visit the profile supplier, which information and access are sufficient to enable the media property (i) to place or recognize a tag on the online access device and (ii) to electronically associate the tag or an identifier thereof with the one or more provided profile attributes, which tag is readable by the selected media property.

34. The method of claim 26 wherein the providing in part (b) comprises providing to the media property information sufficient to enable the media property (i) to place or recognize a tag on an access device other than an online access device used by the user to electronically visit the first profile supplier and (ii) to electronically associate the tag or an identifier thereof with the one or more provided profile attributes, which tag is readable by the selected media property.

35. The method of claim 26 wherein the providing in part (b) comprises providing to the media property information sufficient to enable the media property (i) to place or recognize a tag on a television set-top box used by the user to receive television service and (ii) to electronically associate the tag or an identifier thereof with the one or more provided profile attributes, which tag is readable by the selected media property.

36. The method of claim 26 wherein the providing in part (b) comprises creating or updating a database record linking the one or more profile attributes and the user.

37. The method of claim 26 further comprising selecting out of the current or previous profile information the one or more profile attributes provided in part (b).

38. The method of claim 37 wherein one or more profile attributes provided in part (b) are selected based on whether the profile attribute was provided previously to the selected media property for the user or on a time interval since the profile attribute was provided previously to the selected media property for the user.

39. The method of claim 37 wherein one or more profile attributes provided in part (b) are selected based on calculated advertising revenue or profit potentially realizable from the media property for providing the profile attribute to the selected media property for the user.

40. The method of claim 37 wherein one or more profile attributes provided in part (b) are selected out of profile attributes not previously provided to the selected media property for the user.

41. The method of claim 26 further comprising receiving with at least one of the computers the individualized requests for specific profiles, kinds of profiles, or profiles having specific attributes of interest to each media property of the multitude.

42. A system comprising one or more computers, which system is structured and connected to:
(a) responsive to receiving via the Internet profile information about a user collected as a result of a current electronic visit by the user to a first profile supplier, select automatically, with at least one of the computers, a set made up of a plurality of media properties out of a multitude of media properties based on a comparison of user profile information with previously received individualized requests for specific profiles, kinds of profiles, or profiles having specific attributes of interest to each media property of the multitude, wherein the compared user profile information includes the profile information collected during the current electronic visit and profile information collected during at least one previous electronic visit by the user to the first profile supplier or a second profile supplier; and
(b) provide automatically, with at least one of the computers, to one or more of the selected media properties one or more profile attributes from the user profile information in a manner that enables the selected media property to electronically associate the provided profile attribute with the user.

43. A computer-readable medium encoded with a computer program, wherein execution of the computer program by one or more computers causes the one or more computers to perform a method comprising:
(a) responsive to receiving via the Internet profile information about a user collected as a result of a current electronic visit by the user to a first profile supplier, automatically selecting, with at least one of the computers, a set made up of a plurality of media properties out of a multitude of media properties based on a comparison of user profile information with previously received individualized requests for specific profiles, kinds of profiles, or profiles having specific attributes of interest to each media property of the multitude, wherein the compared user profile information includes the profile information collected during the current electronic visit and profile information collected during at least one previous electronic visit by the user to the first profile supplier or a second profile supplier; and
(b) automatically providing, with at least one of the computers, to one or more of the selected media properties one or more profile attributes from the user profile information in a manner that enables the selected media property to electronically associate the provided profile attribute with the user.

44. A method comprising downloading over the Internet to one or more client computers a computer program, wherein execution of the computer program by at least one of the computers causes the executing computers to perform a method comprising:
(a) responsive to receiving via the Internet profile information about a user collected as a result of a current electronic visit by the user to a first profile supplier, automatically selecting, with at least one of the computers, a set made up of a plurality of media properties out of a multitude of media properties based on a comparison of user profile information with previously received individualized requests for specific profiles, kinds of profiles, or profiles having specific attributes of interest to each media property of the multitude, wherein the compared user profile information includes the profile information collected during the current electronic visit and profile information collected during at least one previous electronic visit by the user to the first profile supplier or a second profile supplier; and
(b) automatically providing, with at least one of the computers, to one or more of the selected media properties one or more profile attributes from the user profile information in a manner that enables the selected media property to electronically associate the provided profile attribute with the user.

45. A method performed by a profile owner for providing collected profiles using one or more computers, the method comprising:
(a) responsive to receiving via the Internet current profile information about a user that electronically visited a profile supplier, automatically selecting, with at least one of the computers, one or more media properties that have not previously been provided with cookie-syncing information for the user or for which a time interval since previously providing such cookie-syncing information exceeds a predetermined time limit;
(b) automatically providing, with at least one of the computers, to one or more of the selected media properties information, related to a profile owner cookie on an online access device used by the user to electronically visit the profile supplier, that is sufficient to enable the selected media property to establish cookie-syncing by the selected media property with respect to the user; and
(c) automatically providing, with at least one of the computers, to one or more of the selected media properties one or more corresponding profile attributes from subsequent, current, or previous profile information about the user together with information related to the profile owner cookie, whereby, as a result of the cookie-syncing, the selected media properties can each electronically associate the corresponding one or more provided profile attributes with the user.

46. The method of claim 45 wherein the information related to the profile owner cookie and provided in part (b) or part (c) comprises a cookie identifier included in the profile owner cookie.

47. The method of claim 45 wherein the information related to the profile owner cookie and provided in part (b) or part (c) comprises a cookie pseudonym associated with a profile owner cookie identifier.

48. The method of claim 45 wherein the one or more computers include at least one server connected to the Internet.

49. The method of claim 45 wherein the one or more computers include an online access device used by the user to electronically visit the profile supplier.

50. The method of claim 45 wherein media properties are selected in part (a) up to a predetermined limit on the number of media properties to be selected responsive to each reception of current profile information.

51. The method of claim 45 wherein the information provided in part (b) and access to an online access device used by the user to electronically visit the profile supplier are sufficient to enable the media property to place or recognize a tag on the online access device to establish the cookie-syncing.

52. The method of claim 45 wherein the information provided in part (b) is sufficient to enable the media property to place or recognize a tag on an access device, other than an online access device used by the user to electronically visit the profile supplier, to establish the cookie-syncing.

53. The method of claim 45 wherein the information provided in part (b) is sufficient to enable the media property to place or recognize a tag on a television set-top box, used by the user to receive television service, to establish the cookie-syncing.

54. The method of claim 45 wherein the providing in part (c) comprises creating or updating a database record linking the one or more profile attributes and the user.

55. The method of claim 45 wherein the providing in part (c) comprises sending to each of the selected media properties a corresponding file that includes the one or more profile attributes and the information of part (c) related to the profile owner cookie.

56. The method of claim 45 wherein the providing in part (c) comprises providing access to each of the selected media properties to a corresponding file that includes the one or more profile attributes and the information of part (c) related to the profile owner cookie.

57. The method of claim 45 further comprising selecting out of the subsequent, current, or previous profile information the one or more profile attributes provided in part (c), based on a comparison of subsequent, current, or previous profile information received about the user with previously received individualized requests for specific profiles, kinds of profiles, or profiles having specific attributes of interest to each selected media property.

58. The method of claim 57 wherein one or more profile attributes provided in part (c) are selected based on whether the profile attribute was provided previously to the selected media property for the user or on a time interval since the profile attribute was provided previously to the selected media property for the user.

59. The method of claim 57 wherein one or more profile attributes provided in part (c) are selected based on calculated advertising revenue or profit potentially realizable from the media property for providing the profile attribute to the selected media property for the user.

60. The method of claim 57 wherein the one or more profile attributes provided in part (c) are selected out of profile attributes not previously provided to the selected media property for the user.

61. The method of claim 57 further comprising receiving with at least one of the computers the individualized requests for specific profiles, kinds of profiles, or profiles having specific attributes of interest to each media property of the multitude.

62. A system comprising one or more computers, which system is structured and connected to:
(a) responsive to receiving via the Internet current profile information about a user that electronically visited a profile supplier, select automatically, with at least one of the computers, one or more media properties that have not previously been provided with cookie-syncing information for the user or for which a time interval since previously providing such cookie-syncing information exceeds a predetermined time limit;
(b) provide automatically, with at least one of the computers, to one or more of the selected media properties information, related to a profile owner cookie on an online access device used by the user to electronically visit the profile supplier, that is sufficient to enable the selected media property to establish cookie-syncing by the selected media property with respect to the user; and
(c) provide automatically, with at least one of the computers, to one or more of the selected media properties one or more corresponding profile attributes from subsequent, current, or previous profile information about the user together with information related to the profile owner cookie, whereby, as a result of the cookie-syncing, the selected media properties can each electronically associate the corresponding one or more provided profile attributes with the user.

63. A computer-readable medium encoded with a computer program, wherein execution of the computer program by one or more computers causes the one or more computers to perform a method comprising:
(a) responsive to receiving via the Internet current profile information about a user that electronically visited a profile supplier, automatically selecting, with at least one of the computers, one or more media properties that have not previously been provided with cookie-syncing information for the user or for which a time interval since previously providing such cookie-syncing information exceeds a predetermined time limit;
(b) automatically providing, with at least one of the computers, to one or more of the selected media properties information, related to a profile owner cookie on an online access device used by the user to electronically visit the profile supplier, that is sufficient to enable the selected media property to establish cookie-syncing by the selected media property with respect to the user; and
(c) automatically providing, with at least one of the computers, to one or more of the selected media properties one or more corresponding profile attributes from subsequent, current, or previous profile information about the user together with information related to the profile owner cookie, whereby, as a result of the cookie-syncing, the selected media properties can each electronically associate the corresponding one or more provided profile attributes with the user.

64. A method comprising downloading over the Internet to one or more client computers a computer program, wherein execution of the computer program by at least one of the computers causes the executing computers to perform a method comprising:
(a) responsive to receiving via the Internet current profile information about a user that electronically visited a profile supplier, automatically selecting, with at least one of the computers, one or more media properties that have not previously been provided with cookie-syncing information for the user or for which a time interval since previously providing such cookie-syncing information exceeds a predetermined time limit;
(b) automatically providing, with at least one of the computers, to one or more of the selected media properties information, related to a profile owner cookie on an online access device used by the user to electronically visit the profile supplier, that is sufficient to enable the selected media property to establish cookie-syncing by the selected media property with respect to the user; and
(c) automatically providing, with at least one of the computers, to one or more of the selected media properties one or more corresponding profile attributes from subsequent, current, or previous profile information about the user together with information related to the profile owner cookie, whereby, as a result of the cookie-syncing, the selected media properties can each electronically associate the corresponding one or more provided profile attributes with the user.

65. A method for providing collected profiles using one or more computers, the method comprising, responsive to receiving via the Internet current profile information about a user that electronically visited a profile supplier, automatically, with at least one of the computers, electronically redirecting the user via the Internet to a server of a media property, which electronic redirect includes one or more profile attributes from previous profile information about the user.

66. The method of claim 65 wherein the electronic redirect additionally includes one or more profile attributes from the current profile information about the user.

67. The method of claim 65 wherein the electronic redirect enables the media property to associate the profile attributes with a tag on an access device of the user that is readable by the media property.

68. The method of claim 65 wherein the profile attributes comprise behavioral attributes.

69. The method of claim 65 further comprising, responsive to receiving the current profile information about the user, automatically identifying, with at least one of the computers, the media property out of a multitude of media properties based on a comparison of current or previous profile information received about the user with previously received individualized requests for specific profiles, kinds of profiles, or profiles having specific attributes of interest to each media property of the multitude.

70. The method of claim 65 further comprising:
(a) responsive to receiving via the Internet the current profile information about the user, automatically identifying, with at least one of the computers, a set made up of a plurality of media properties out of a multitude of media properties based on a comparison of current or previous profile information received about the user with previously received individualized requests for specific profiles, kinds of profiles, or profiles having specific attributes of interest to each media property of the multitude; and
(b) automatically selecting, with at least one of the computers, a subset of one or more media properties out of those identified in part (a), which subset includes the media property to which the user is electronically redirected, wherein each media property of the subset is selected based on a corresponding media property selection history.

71. A method for receiving collected profiles using one or more computers, the method comprising receiving from a profile owner via the Internet, with at least one of the computers, an electronic redirect of a user that electronically visited a profile supplier, which electronic redirect is responsive to the profile owner receiving current profile information about the user and includes one or more profile attributes from previous profile information about the user.

72. The method of claim 71 wherein the electronic redirect additionally includes one or more profile attributes from the current profile information about the user.

73. The method of claim 71 further comprising placing or recognizing a tag on an access device of the user and associating the profile attributes with the tag.

74. The method of claim 71 wherein the profile attributes comprise behavioral attributes.

75. The method of claim 71 wherein the profile attributes are received in response to a request sent to the profile owner for specific profiles, kinds of profiles, or profiles having specific attributes of interest.
